(19) United States
(12) Patent Application Publication
(10) Pub. No.: US 2012/0038332 A1
(43) Pub. Date: Feb. 16, 2012

(54) LINEAR VOLTAGE REGULATOR AND CURRENT SENSING CIRCUIT THEREOF

(75) Inventor: Yung-Cheng LIN, Zhubei City (TW)

(73) Assignee: NOVATEK MICROELECTRONICS CORP., Hsinchu (TW)

(21) Appl. No.: 13/194,628

(22) Filed: Jul. 29, 2011

(30) Foreign Application Priority Data
Aug. 10, 2010 (TW) 99126663

(51) Int. Cl. G05F 1/573

(52) U.S. Cl. 323/277

(57) ABSTRACT

A linear regulator and a current sensing circuit are provided. The linear regulator comprises a pass transistor, a compensation capacitor, a variable resistor, an error amplifier and a current sensing circuit comprising a sense transistor controlled by the error amplifier and a voltage follower coupled with the second terminal of the pass transistor and the second terminal of the sense transistor. The sense transistor receives an input voltage, and generates a sense current proportional to a pass current. The voltage follower controls the voltage at the second terminal of the sense transistor to be the same as that at the second terminal of the pass transistor, and adjusts the resistance of the variable resistor according to the voltages at the second terminal of the pass transistor, the voltage at the second terminal of the sense transistor, and the sense current flowing through the sense transistor.

This application claims the benefit of Taiwan application Serial No. 99126663, filed Aug. 10, 2010, the subject matter of which is incorporated herein by reference.

### BACKGROUND OF THE INVENTION

1. Field of the Invention

The invention relates in general to a linear regulator and a current sensing circuit thereof, and more particularly to a linear regulator with pole-zero tracking function and a current sensing circuit thereof.

2. Description of the Related Art

Referring to FIG. 1, a circuit diagram of a first conventional linear regulator is shown. The conventional linear regulator 10 comprises a pass transistor M_{NO}, a compensation capacitor C_{C}, a feedback network 41 and an amplifier A₁. The first terminal of the pass transistor M_{NO} receives an input voltage V_{IN}, and the second terminal of the pass transistor M_{NO} outputs the output voltage V_{OUT} to a load. A first terminal and a second terminal of the pass transistor M_{NO} are realized by such as a drain and a source, respectively. The feedback network 41 is coupled between the inverting input terminal of the error amplifier A₁ and the second terminal of the pass transistor M_{NO}. The feedback network 41 further comprises resistors R₁ and R₂. The feedback network 41 divides the output voltage V_{OUT} by using the resistors R₁ and R₂, and then outputs a feedback voltage V_{F} to the inverting input terminal of the error amplifier A₁. The output terminal of the error amplifier A₁ couples the pass transistor M_{NO} and the compensation capacitor C_{C}, and the non-inverting input terminal of the error amplifier A₁ receives a reference voltage V_{REF}. The error amplifier A₁ controls the pass transistor M_{NO} according to the feedback voltage V_{F} and the reference voltage V_{REF} to adjust the voltage value of the output voltage V_{OUT}.

The error amplifier A₁ possesses high output impedance for providing sufficient voltage gain, and the second terminal of the pass transistor M_{NO} possesses low output impedance. In the design of frequency compensation, a compensation capacitor C_{C} is added to the output terminal X of the error amplifier A₁ to generate a dominant pole frequency, and the non-dominant pole frequency is determined according to the equivalent resistance and the capacitance of the output node V_{OUT}, and is approximately equal to

$$\frac{{gm}_{MNO}}{{C}_{L}} ,$$

wherein gm_{MNO} denotes the transconductance of the pass transistor M_{NO}, and C_{L} denotes the equivalent load capacitance.

When the load current I_{LOAD} is too small or the equivalent load capacitance C_{L} is too large, the non-dominant pole frequency will move towards low frequencies, and approach the dominant pole frequency. Thus, the phase margin will degrade, making the linear regulator unstable. To assure the stability of the linear regulator, the dominant pole frequency must be placed at even lower frequencies. Consequently, the bandwidth of the linear regulator is even lower and the response time becomes slower.

Referring to FIG. 2, a circuit diagram of a second conventional linear regulator is shown. The conventional linear regulator 20 is different from the conventional linear regulator 10 in that a resistor R_{Z} of the conventional linear regulator 20 is serially connected to a terminal of the compensation capacitor C_{C} to generate a zero on the left half place (LHP), wherein the zero frequency is

$$\frac{1}{CcRz} .$$

The zero frequency can be used to cancel the non-dominant pole frequency of the output node V_{OUT} so as to increase the phase margin, not only increasing the stability of the linear regulator but also increasing the bandwidth.

However, the above compensation technique still has a problem, that is, both the resistance of the resistor R_{Z} and the transconductance of the transconductor gm of the pass transistor M_{NO} vary with the manufacturing process. Since the variation in the resistance of the resistor R_{Z} is uncorrelated with the variation in the transconductance gm_{MNO} of the pass transistor M_{NO}, the zero frequency cannot reliably be use to cancel the non-dominant pole frequency.

Referring to FIG. 3, a circuit diagram of a third conventional linear regulator is shown. The conventional linear regulator 30 is different from the conventional linear regulator 20 in that the conventional linear regulator 30 replaces the resistor R_{Z} of the conventional linear regulator 20 with an N-type metal-oxide-semiconductor (MOS) transistor M_{NZ} which is identical to the type of the pass transistor M_{NO}. The control terminal of the N-type MOS transistor M_{NZ} is coupled to a constant voltage V_{b}, and the N-type MOS transistor M_{NZ} operates in the triode region to form an equivalent resistor, so the variation in the resistance of the N-type MOS transistor M_{NZ} Is correlated with the variation in the transconductance gm_{MNO} of the pass transistor M_{NO}.

However, as the transconductance gm_{MNO} of the pass transistor M_{NO} changes with the load current I_{LOAD}, the frequency variation of the non-dominant pole may be large during the system operation. The fixed zero frequency cannot be used effectively to cancel the non-dominant pole frequency at the output node V_{OUT}, and the phase margin may still be insufficient under certain levels of load current I_{LOAD}.

### SUMMARY OF THE INVENTION

The invention is directed to a linear regulator and a current sensing circuit thereof, wherein the current sensing circuit correspondingly adjusts the variable resistor coupled to the compensation capacitor by sensing the pass current flowing through the pass transistor so as to achieve the pole-zero tracking effect.

According to a first aspect of the present invention, a linear regulator is provided. The linear regulator comprises a pass transistor, a compensation capacitor, a variable resistor, a feedback network, an error amplifier and a current sensing circuit. The first terminal of the pass transistor receives an input voltage, and the second terminal of the pass transistor outputs an output voltage. The variable resistor is coupled to the compensation capacitor, and the feedback network outputs a feedback voltage. The error amplifier controls the pass transistor according to the feedback voltage and the reference voltage. The current sensing circuit comprises a sense transistor and a voltage follower. The sense transistor is controlled by the error amplifier. The first terminal of the sense transistor receives an input voltage. The sense transistor generates a sense current, which is proportional to the pass current flowing through the pass transistor. The voltage follower couples the second terminal of the pass transistor and the second terminal of the sense transistor, and controls the voltage at the second terminal of the sense transistor to be the same as that at the second terminal of the pass transistor. The voltage follower adjusts the resistance of the variable resistor according to the voltage at the second terminal of the pass transistor, the voltage at the second terminal of the sense transistor, and the sense current flowing through the sense transistor.

According to a second aspect of the present invention, a current sensing circuit is provided. The current sensing circuit is used in the linear regulator. The current sensing circuit comprises a sense transistor and a voltage follower. The sense transistor and the pass transistor of the linear regulator are controlled by the error amplifier of the linear regulator, and the first terminal of the sense transistor and the first terminal of the pass transistor receive an input voltage. The sense current is proportional to the pass current flowing through the pass transistor. The voltage follower couples the second terminal of the pass transistor and the second terminal of the sense transistor, and controls the voltage at the second terminal of the sense transistor to be the same as that at the second terminal of the pass transistor. The voltage follower adjusts the resistance of the variable resistor according to the voltage at the second terminal of the pass transistor, the voltage at the second terminal of the sense transistor, and the sense current flowing through the sense transistor.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 shows a circuit diagram of a first conventional linear regulator;

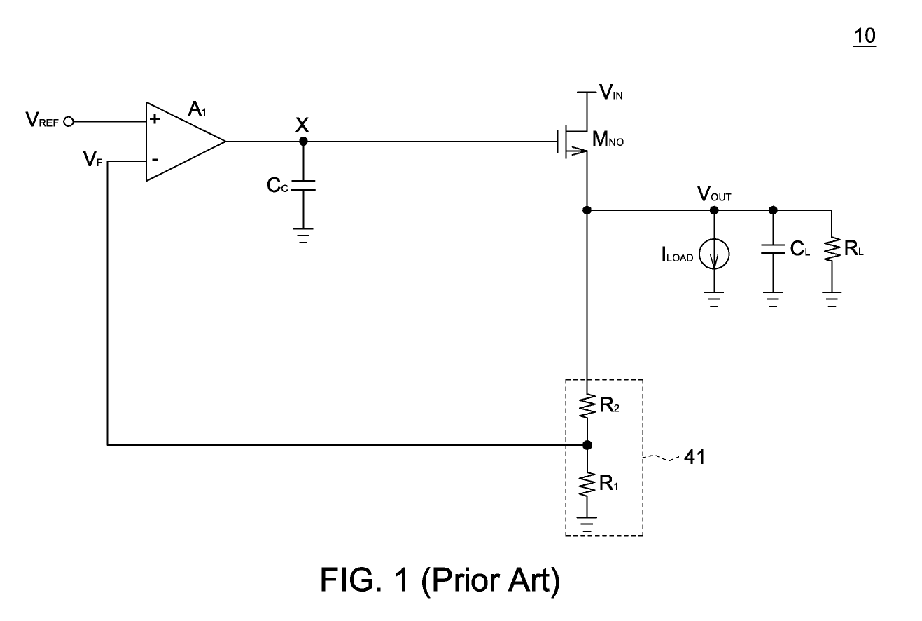

FIG. 2 shows a circuit diagram of a second conventional linear regulator;

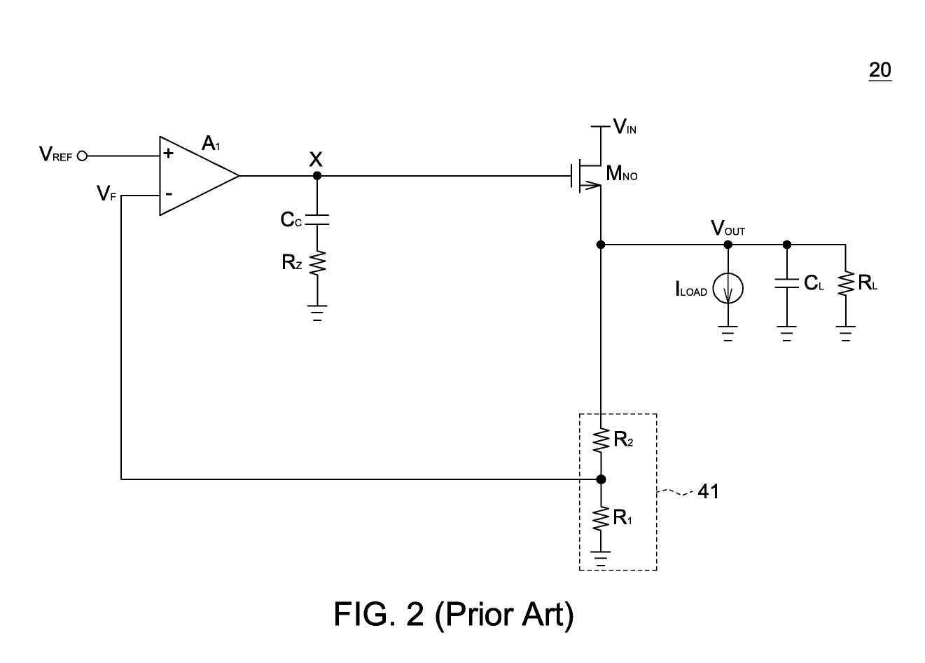

FIG. 3 shows a circuit diagram of a third conventional linear regulator;

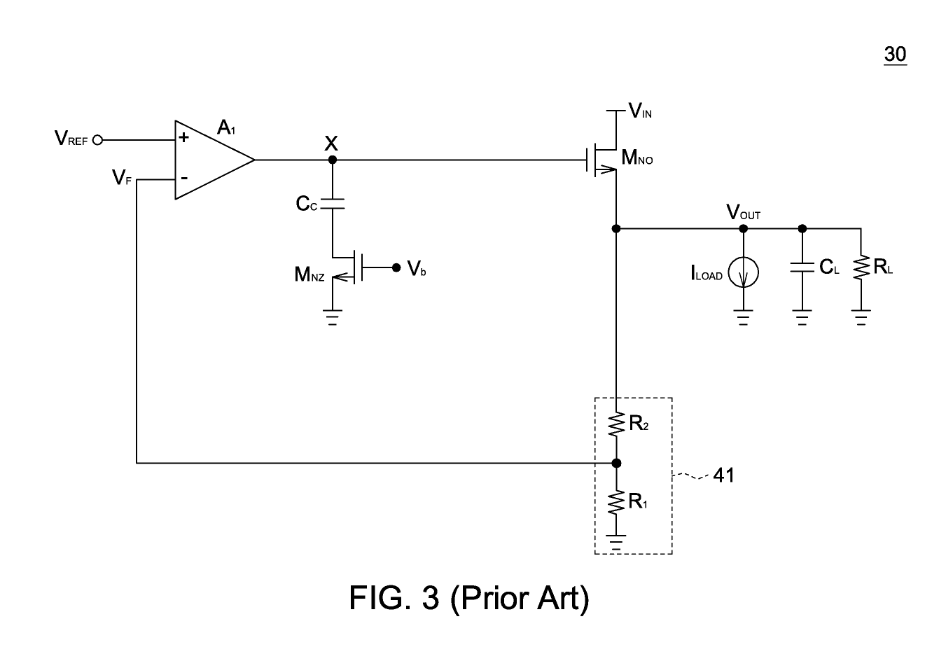

FIG. 4 shows an architect diagram of a linear regulator;

FIG. 5 shows a circuit diagram of a linear regulator of a first embodiment;

FIG. 6 shows a circuit diagram of a linear regulator of a second embodiment;

FIG. 7 shows a circuit diagram of a linear regulator of a third embodiment;

FIG. 8 shows a circuit diagram of a linear regulator of a fourth embodiment;

FIG. 9 shows a circuit diagram of a linear regulator of a fifth embodiment;

FIG. 10 shows a circuit diagram of a linear regulator of a sixth embodiment.

### DETAILED DESCRIPTION OF THE INVENTION

To more reliably cancel the non-dominant pole frequency by introducing a left half plane (LHP) zero frequency, a number of linear regulators and their current sensing circuits are provided in the following embodiments. The linear regulator dynamically adjusts the resistance of the variable resistor coupled to the compensation capacitor by sensing the pass current flowing through the pass transistor with a current sensing circuit so as to achieve the pole-zero tracking effect. The linear regulator comprises a pass transistor, a compensation capacitor, a variable resistor, a feedback network, an error amplifier and a current sensing circuit. The first terminal of the pass transistor receives an input voltage, and the second terminal of the pass transistor outputs an output voltage. The variable resistor is coupled to the compensation capacitor, and the feedback network outputs a feedback voltage. The error amplifier controls the pass transistor according to the feedback voltage and the reference voltage. The current sensing circuit comprises a sense transistor and a voltage follower. The sense transistor is controlled by the error amplifier. The first terminal of the sense transistor receives the input voltage. The sense transistor generates a sense current. The sense current is proportional to the pass current flowing through the pass transistor. The voltage follower couples the second terminal of the pass transistor and the second terminal of the sense transistor, and controls the voltage at the second terminal of the sense transistor to be the same as that at the second terminal of the pass transistor. The voltage follower adjusts the resistance of the variable resistor according to the voltage at the second terminal of the pass transistor, the voltage at the second terminal of the sense transistor, and the sense current flowing through the sense transistor. A number of embodiments are exemplified below for detailed description of the disclosure.

### First Embodiment

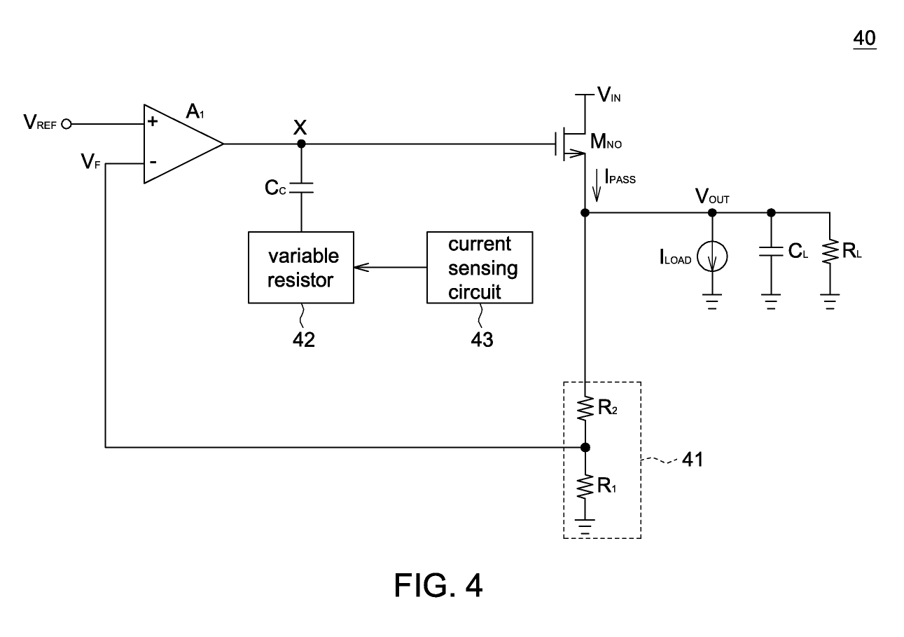

Referring to FIG. 4, an architect diagram of a linear regulator is shown. The linear regulator 40, realized by such as a high drop-out (HDO) linear regulator, comprises a pass transistor M_{NO}, a compensation capacitor C_{C}, a feedback network 41, an error amplifier A₁, a variable resistor 42 and a current sensing circuit 43. For convenience of elaboration, the pass transistor M_{NO} of FIG. 4 is exemplified by an N-type metal-oxide-semiconductor (MOS) transistor. However, the type of the pass transistor is not limited thereto, and the pass transistor can also be realized by a P-type MOS transistor, an NPN bipolar junction transistor (BJT) or a PNP bipolar junction transistor.

A first terminal of the pass transistor M_{NO} receives an input voltage V_{IN}, and a second terminal of the pass transistor M_{NO} outputs an output voltage V_{OUT}. A first terminal and a second terminal of the pass transistor M_{NO} are realized by a drain and a source, respectively. The variable resistor 42 is coupled to the compensation capacitor C_{C} to generate a zero located on the left half plane. The generated zero frequency can be used to cancel the non-dominant pole frequency located at the output node V_{OUT} of the linear regulator 40 to increase the phase margin, so that the stability and bandwidth of the linear regulator 40 are further increased.

The feedback network 41, coupled between an inverting input terminal of the error amplifier A₁ and a second terminal of the pass transistor M_{NO}, further comprises resistors R₁ and R₂. The feedback network 41 divides the output voltage V_{OUT} by using the resistors R₁ and R₂ so as to output a feedback voltage V_{F} to the inverting input terminal of the error amplifier A₁. An output terminal of the error amplifier A₁ couples the pass transistor M_{NO} and the compensation capacitor C_{C}, and the non-inverting input terminal of the error amplifier A₁ receives a reference voltage V_{REF}. The error amplifier A₁ controls the pass transistor M_{NO} according to the feedback voltage V_{F} and the reference voltage V_{REF}. The current sensing circuit 43 dynamically adjusts the variable resistor 42 according to the pass current Iₚₐₛₛ flowing through the pass transistor M_{NO} to achieve the pole-zero tracking effect.

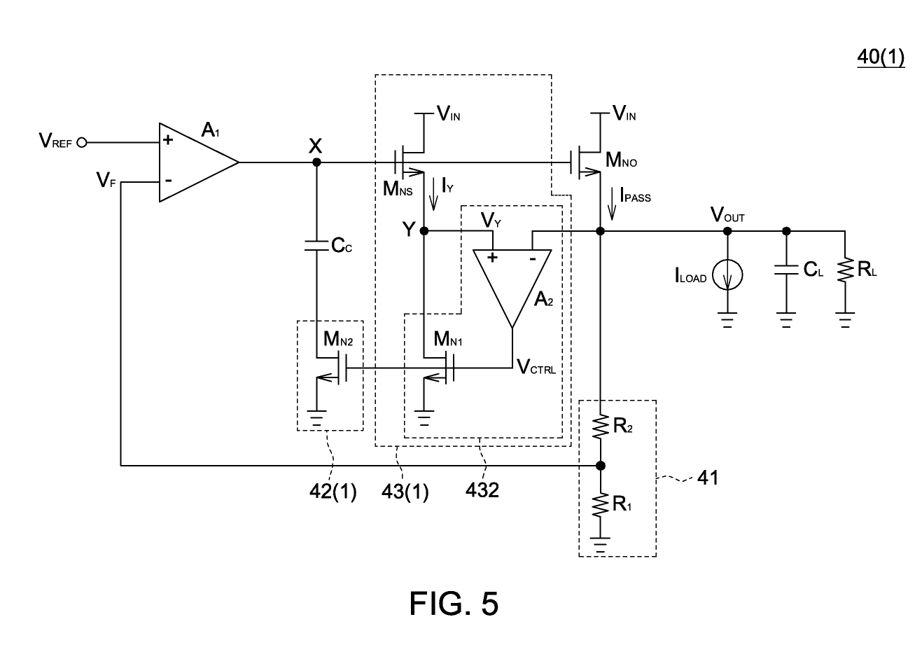

Referring to FIG. 5, a circuit diagram of a linear regulator of a first embodiment is shown. In the first embodiment, the linear regulator 40, the variable resistor 42 and the current sensing circuit 43 are exemplified by a linear regulator 40(1), a variable resistor 42(1) and a current sensing circuit 43(1), respectively. The current sensing circuit 43(1) comprises a sense transistor M_{NS} and a voltage follower 432. For convenience of elaboration, the sense transistor M_{NS} of FIG. 5 is exemplified by an N-type metal-oxide-semiconductor (MOS) transistor. However, the type of the sense transistor is not limited thereto, and the sense transistor can also be realized by a P-type MOS transistor, an NPN bipolar junction transistor (BJT) or a PNP bipolar junction transistor.

A first terminal and a second terminal of the sense transistor M_{NS} are realized by a drain and a source, respectively. The sense transistor M_{NS} is controlled by the error amplifier A₁. A first terminal of the sense transistor M_{NS} receives an input voltage V_{IN}. The sense transistor M_{NS} senses the pass current Iₚₐₛₛ flowing through the pass transistor M_{NO} to generate a sense current I_{y} which is proportional to the pass current Iₚₐₛₛ. The voltage follower 432 couples a second terminal of the pass transistor M_{NO} and a second terminal of the sense transistor M_{NS}, and controls the voltage at the second terminal of the sense transistor M_{NO} to be the same as that at the second terminal of the pass transistor M_{NS}. The voltage follower 432 adjusts the resistance of the variable resistor 42(1) according to the voltage at the second terminal of the pass transistor M_{NO}, the voltage at the second terminal of the sense transistor M_{NS}, and the sense current I_{y} flowing through the sense transistor M_{NS}.

The voltage follower 432 further comprises a transistor M_{N1} and a sense amplifier A₂. The transistor M_{N1} couples the sense transistor M_{NS}. The sense current I_{Y} flows through the transistor M_{N1}. The transistor M_{N1} is realized by such as an N-type metal-oxide-semiconductor (MOS) transistor. A first terminal and a second terminal of the transistor M_{N1} are realized by such as a drain and a source, respectively. An inverting input terminal of the sense amplifier A₂ is coupled to the second terminal of the pass transistor M_{NO} and the feedback network 41. A non-inverting input terminal of the sense amplifier A₂ is coupled to the second terminal of the sense transistor M_{NS}. The output terminal of the sense amplifier A₂ is coupled to a control terminal of the transistor M_{N1}. The sense amplifier A₂ controls the transistor M_{N1} according to the voltage at the second terminal of the pass transistor M_{NO}, the voltage at the second terminal of the sense transistor M_{NS}, and the sense current flowing through the sense transistor M_{NS}. The voltage at the second terminal of the pass transistor M_{NO} and that at the second terminal of the sense transistor M_{NS} are the output voltage V_{OUT} and the terminal voltage V_{y}, respectively. The variable resistor 42(1) comprises a transistor M_{N2}, wherein a first terminal and a second terminal of the transistor M_{N2} are realized by such as a drain and a source, respectively. The transistor M_{N2} is coupled between the compensation capacitor C_{C} and a ground terminal, and is controlled by the sense amplifier A₂. The transistor M_{N2} operates in the triode region to form an equivalent resistor.

The transistor M_{N1} and the sense amplifier A₂ are connected to form a negative feedback. The voltage at the inverting input terminal of the sense amplifier A₂ is the same with that of the non-inverting input terminal, that is, the output voltage V_{OUT} is equal to the terminal voltage V_{Y}. Thus, the terminal voltages of the sense transistor M_{NS} is the same with the terminal voltages of the pass transistor M_{NO}, so that a current mirror is formed by the sense transistor M_{NS} and the pass transistor M_{NO}. The ratio of the pass current Iₚₐₛₛ to t the sense current I_{Y} is expressed as

$$\frac{{I}_{pass}}{{I}_{Y}} = \frac{{( \frac{W}{L} )}_{MNO}}{{( \frac{W}{L} )}_{MNS}} ,$$

wherein

$${( \frac{W}{L} )}_{MNO} and {( \frac{W}{L} )}_{MNS}$$

are respectively the width/length ratio of the transistor channel of the pass transistor M_{NO} and that of the sense transistor M_{NS}. By using the current sensing circuit 43(1) with negative feedback, the sense current I_{Y} and the control voltage V_{CTRL} will change with the load current I_{LOAD}, so that the current can be sensed. In addition, the sense current I_{Y} flowing through the sense transistor M_{NS} is equivalent to the current flowing through the transistor M_{N1}, and a current mirror is formed by the transistor M_{N1} and the transistor M_{N2}. Therefore, the sense current I_{Y} and the control voltage V_{CTRL} will be copied to the transistor M_{N2} and used as the signals required for pole-zero tracking.

As the load current I_{LOAD} increases, the pass current Iₚₐₛₛ flowing through the pass transistor M_{NO} and the voltage of the node X also increase accordingly. Meanwhile, the non-dominant pole at the output node V_{OUT} of the linear regulator 40(1) moves towards higher frequencies. Since the pass transistor M_{NO} and the sense transistor M_{NS} form a current mirror because of the same terminal voltages, the sense current I_{Y} flowing through the sense transistor M_{NS} also increases. Due to the feedback control of the current sensing circuit 43(1), the control voltage V_{CTRL} increases so that the current flowing through the transistor M_{N1} is controlled to be equal to the sense current I_{Y}. The equivalent resistance of the transistor M_{N2} will decrease due to the increase of the control voltage V_{CTRL}. Consequently, the zero on the left half plane moves towards higher frequencies accordingly to achieve the pole-zero tracking effect. Since the type of the pass transistor M_{NO} is identical to the type of the transistor M_{N2}, and the generated zero frequency can track the non-dominant pole frequency as the load current I_{LOAD} changes, the frequency compensation of the linear regulator 40(1) will not vary with the manufacturing process, the temperature, the input voltage V_{IN}, and the load current I_{LOAD}.

### Second Embodiment

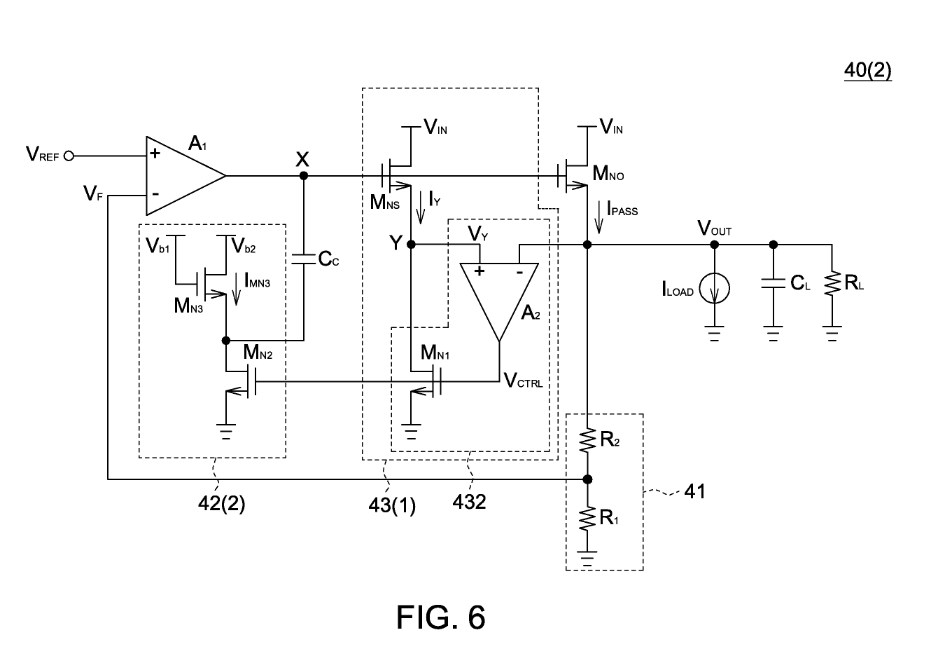

Referring to FIG. 6, a circuit diagram of a linear regulator of a second embodiment is shown. In the second embodiment, the linear regulator 40, the variable resistor 42 and the current sensing circuit 43 are exemplified by a linear regulator 40(2), a variable resistor 42(2) and a current sensing circuit 43(1), respectively. The second embodiment is different from the first embodiment mainly in the variable resistor 42(2), which further comprises a transistor M_{N3} in addition to the transistor M_{N2}. A first terminal and a second terminal of the transistor M_{N3} are realized by such as a drain and a source, respectively. A control terminal of the transistor M_{N3} is realized by such as a gate. The first terminal of the transistor M_{N3} is coupled to a control terminal of the transistor M_{N3}. The second terminal of the transistor M_{N3} is coupled to the compensation capacitor C_{C} and the first terminal of the transistor M_{N2}. The transistor M_{N3} operates in the saturation region to form an equivalent resistor.

A biased current I_{MN3} of the transistor M_{N3} is provided by the current mirror formed by the transistor M_{N1} and the transistor M_{N2}, wherein the biased current I_{MN3} is generated according to the pass current Iₚₐₛₛ. In the linear regulator 40(2), the equivalent resistance for determining the zero frequency is expressed as

$$\frac{1}{{gm}_{MN 3}} ,$$

and the equivalent resistance for determining the non-dominant pole frequency at the output node V_{OUT} is expressed as

$$\frac{1}{{gm}_{MNO}} ,$$

wherein gm_{MN3} and gm_{MNO} respectively are the transconductance of the transistor M_{N3} and the pass transistor M_{NO}. The ratio of the equivalent resistance for determining the zero frequency to the equivalent resistance for determining the non-dominant pole frequency at the output node V_{OUT} is expressed as

$$\sqrt{\frac{{I}_{pass}}{{I}_{MN 3}}} ,$$

which can also be expressed as the width/length ratio of the transistors because of the property of current mirror. Thus, the ratio of the equivalent resistance for determining the zero frequency to the equivalent resistance for determining the non-dominant pole frequency at the output node V_{OUT} is independent of the electron mobility rate μₙ, the gate oxide capacitance Cox and the threshold voltage V_{TH} of the transistor. Since the ratio of the equivalent resistance for determining the zero frequency to the equivalent resistance for determining the non-dominant pole frequency at the output node V_{OUT} is a constant, the frequency compensation of the linear regulator 40(2) will not vary with the manufacturing process, the temperature, the input voltage V_{IN}, and the load current I_{LOAD}.

### Third Embodiment

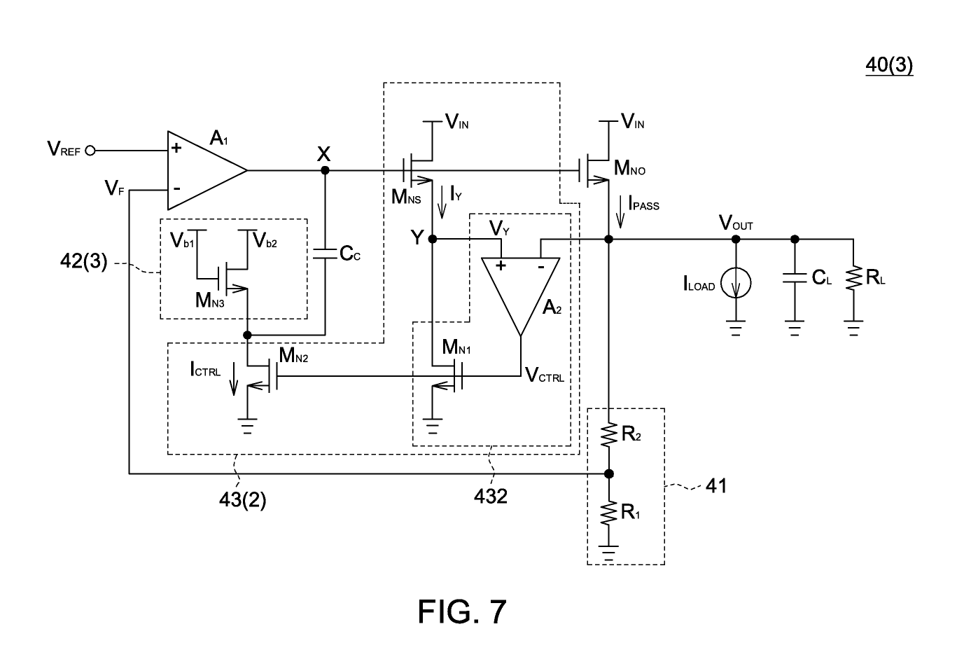

Referring to FIG. 7, a circuit diagram of a linear regulator of a third embodiment is shown. In the third embodiment, the linear regulator 40, the variable resistor 42 and the current sensing circuit 43 are exemplified by a linear regulator 40(3), a variable resistor 42(3) and a current sensing circuit 43(2), respectively. The third embodiment is different from the second embodiment mainly in the variable resistor 42(3) and the current sensing circuit 43(2). The current sensing circuit 43(2) further comprises a transistor M_{N2}, which is coupled between the variable resistor 42(3) and the ground terminal. The control terminal of the transistor M_{N2} is coupled to the output terminal of the sense amplifier A₂. The transistor M_{N2} is controlled by the sense amplifier A₂. The variable resistor 42(3) merely comprises a transistor M_{N3}. A first terminal and a second terminal of the transistor M_{N3} are realized by such as a drain and a source, respectively. A control terminal of the transistor M_{N3} is realized by such as a gate. The first terminal of the transistor M_{N3} is coupled to a constant voltage V_{b2}, and the control terminal of the transistor M_{N3} is coupled to a constant voltage V_{b1}. The voltage value of the constant voltage V_{b1} is the same as the voltage value of the constant voltage V_{b2}. The second terminal of the transistor M_{N3} is coupled to the compensation capacitor C_{C} and the first terminal of the transistor M_{N2}. The transistor M_{N3} operates in the saturation region to form an equivalent resistor. The equivalent resistance of the transistor M_{N3} is controlled by the control current I_{CTRL}, which changes with the sense current I_{Y} and the pass current Iₚₐₛₛ.

### Fourth Embodiment

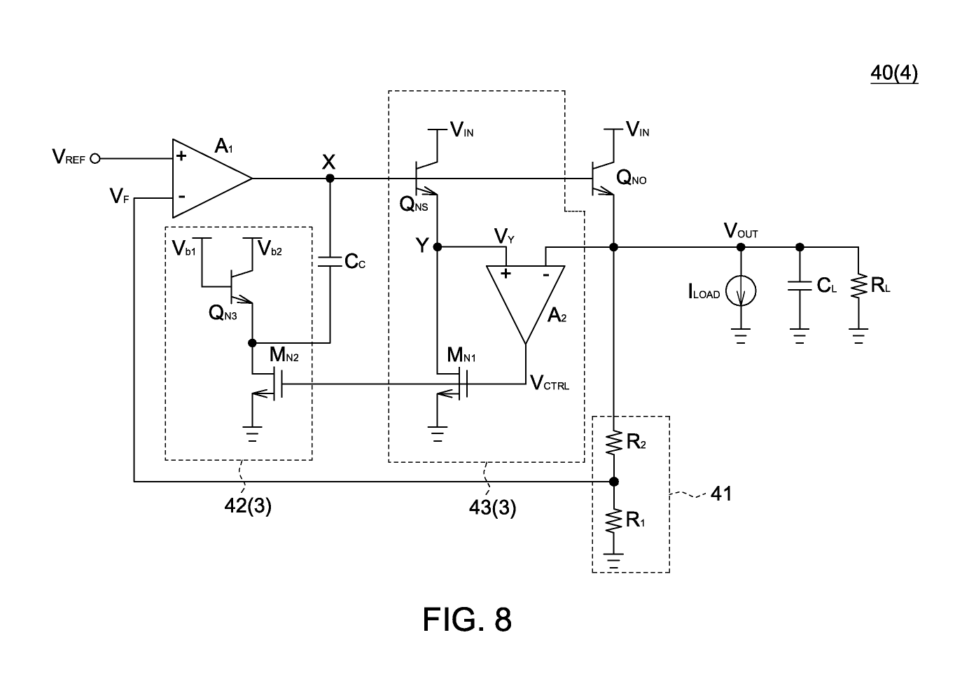

Referring to FIG. 8, a circuit diagram of a linear regulator of a fourth embodiment is shown. In the fourth embodiment, the linear regulator 40, the variable resistor 42 and the current sensing circuit 43 are exemplified by a linear regulator 40(4), a variable resistor 42(3) and a current sensing circuit 43(3), respectively. The fourth embodiment is different from the second embodiment mainly in that the pass transistor M_{NO}, the sense transistor M_{NS} and the transistor M_{N3} of the second embodiment are replaced by a pass transistor Q_{NO}, a sense transistor Q_{NS} and a transistor Q_{N3}, respectively. The pass transistor Q_{NO}, the sense transistor Q_{NS} and the transistor Q_{N3} are realized by an NPN bipolar junction transistor, and the transistor Q_{N3} operates in the active region.

### Fifth Embodiment

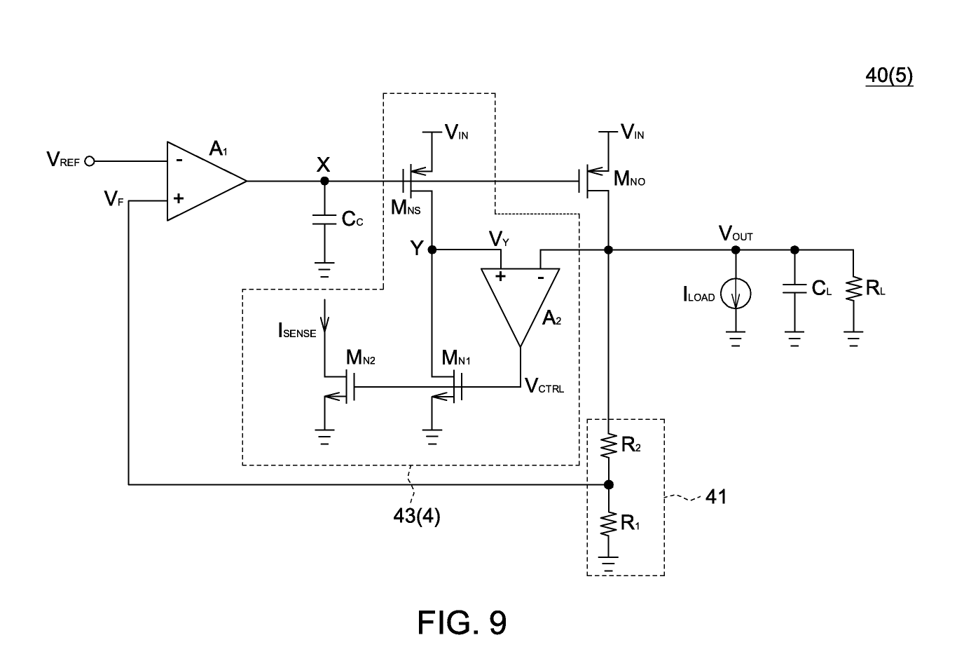

Referring to FIG. 9, a circuit diagram of a linear regulator of a fifth embodiment is shown. In the fifth embodiment, the linear regulator 40 and the current sensing circuit 43 are exemplified by a linear regulator 40(5) and a current sensing circuit 43(4), respectively. The linear regulator 40(5) is realized by such as a low drop-out (LDO) linear regulator. The variable resistor can be realized in many different forms and is thus omitted here. The fifth embodiment is different from the third embodiment mainly in that the pass transistor M_{NO} and the sense transistor M_{NS} of the fifth embodiment are realized by a P-type MOS transistor instead of an N-type MOS transistor as in the third embodiment.

### Sixth Embodiment

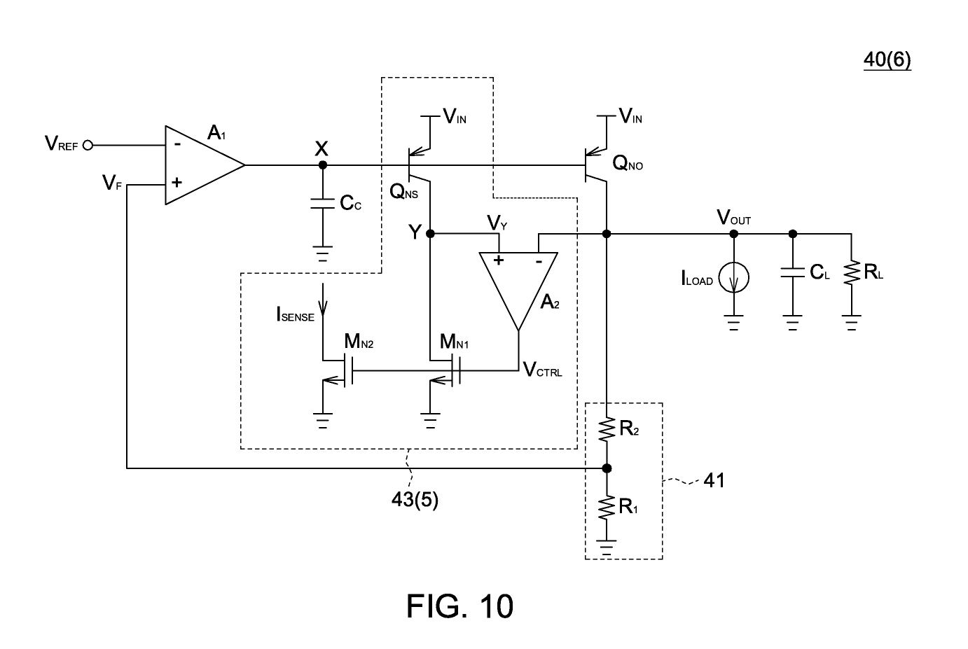

Referring to FIG. 10, a circuit diagram of a linear regulator of a sixth embodiment is shown. In the sixth embodiment, the linear regulator 40 and the current sensing circuit 43 are exemplified by a linear regulator 40(6) and a current sensing circuit 43(5), respectively. The variable resistor can be realized in many different forms and is thus omitted here. The sixth embodiment is different from the fifth embodiment mainly in that the pass transistor M_{NO} and the sense transistor M_{NS} of the fifth embodiment are replaced by a pass transistor Q_{NO} and a sense transistor Q_{NS}, respectively. The pass transistor Q_{NO} and the sense transistor Q_{NS} are respectively realized by a PNP bipolar junction transistor.

The disclosure is exemplified above in a number of embodiments. Any designs capable of correspondingly adjusting the variable resistor coupled to the compensation capacitor by sensing the pass current flowing through the pass transistor with a current sensing circuit to achieve the pole-zero tracking effect are within the scope of the disclosure.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A linear regulator, comprising:
a pass transistor, wherein a first terminal of the pass transistor receives an input voltage, and a second terminal of the pass transistor outputs an output voltage;
a compensation capacitor;
a variable resistor coupled to the compensation capacitor;
a feedback network for outputting a feedback voltage;
an error amplifier for controlling the pass transistor according to the feedback voltage and a reference voltage; and
a current sensing circuit, comprising:
a sense transistor controlled by the error amplifier, wherein a first terminal of the sense transistor receives the input voltage to generate a sense current proportional to a pass current flowing through the pass transistor; and
a voltage follower for coupling the second terminal of the pass transistor and the second terminal of the sense transistor, and controlling the voltage at the second terminal of the sense transistor to be the same as that at the second terminal of the pass transistor, wherein the voltage follower adjusts the resistance of the variable resistor according to the voltage at the second terminal of the pass transistor, the voltage at the second terminal of the sense transistor, and the sense current flowing through the sense transistor.

2. The linear regulator according to claim 1, wherein the voltage follower comprises:
a first transistor for coupling the sense transistor, wherein the sense current flows through the first transistor;
a sense amplifier for controlling the first transistor according to the voltage at the second terminal of the pass transistor, the voltage at the second terminal of the sense transistor, and the sense current flowing through the sense transistor.

3. The linear regulator according to claim 2, wherein the variable resistor comprises:
a second transistor coupled between the compensation capacitor and a ground terminal and controlled by the sense amplifier.

4. The linear regulator according to claim 3, wherein the variable resistor further comprises:
a third transistor, wherein a first terminal of the third transistor is coupled to a control terminal of the third transistor, and a second terminal of the third transistor is coupled to the compensation capacitor and the second transistor.

5. The linear regulator according to claim 2, wherein the current sensing circuit further comprises:
a second transistor coupled between the variable resistor and a ground terminal, and controlled by the sense amplifier.

6. The linear regulator according to claim 5, wherein the variable resistor comprises:
a third transistor, wherein a first terminal of the third transistor is coupled to a first constant voltage, a control terminal of the third transistor is coupled to a second constant voltage, and a second terminal of the third transistor is coupled to the compensation capacitor and the second transistor.

7. The linear regulator according to claim 6, wherein the voltage value of the first constant voltage is equal to that of the second constant voltage.

8. The linear regulator according to claim 5, wherein the sense amplifier comprises:
an inverting input terminal coupled to the second terminal of the pass transistor and the feedback network;
a non-inverting input terminal coupled to the second terminal of the sense transistor; and
an output terminal coupled to the control terminal of the first transistor and the control terminal of the second transistor.

9. The linear regulator according to claim 2, wherein the sense amplifier comprises:
an inverting input terminal coupled to the second terminal of the pass transistor and the feedback network;
a non-inverting input terminal coupled to the second terminal of the sense transistor; and
an output terminal coupled to the control terminal of the first transistor.

10. A current sensing circuit used in a linear regulator, wherein the current sensing circuit comprises:
a sense transistor, wherein the sense transistor and a pass transistor of the linear regulator are controlled by an error amplifier of the linear regulator, and the first terminal of the sense transistor and the first terminal of the pass transistor receive the input voltage and a sense current proportional to a pass current flowing through the pass transistor; and
a voltage follower for coupling the second terminal of the pass transistor and the second terminal of the sense transistor, and controlling the voltage at the second terminal of the sense transistor to be the same as that at the second terminal of the pass transistor, wherein the voltage follower adjusts a variable resistor according to the voltage at the second terminal of the pass transistor, the voltage at the second terminal of the sense transistor, and the sense current flowing through the sense transistor.

11. The current sensing circuit according to claim 10, wherein the voltage follower comprises:
a first transistor for coupling the sense transistor, wherein the sense current flows through the first transistor;
a sense amplifier for controlling the first transistor according to the voltage at the second terminal of the pass transistor, the voltage at the second terminal of the sense transistor, and the sense current flowing through the sense transistor.

12. The current sensing circuit according to claim 11, wherein the sense amplifier comprises:
an inverting input terminal coupled to the second terminal of the pass transistor and the feedback network;
a non-inverting input terminal coupled to the second terminal of the sense transistor; and
an output terminal coupled to the control terminal of the first transistor.

13. The current sensing circuit according to claim 11, further comprising:
a second transistor coupled between the variable resistor and a ground terminal, and controlled by the sense amplifier.

14. The current sensing circuit according to claim 13, wherein the sense amplifier comprises:
an inverting input terminal coupled to the second terminal of the pass transistor and the feedback network;
a non-inverting input terminal coupled to the second terminal of the sense transistor; and
an output terminal coupled to the control terminal of the first transistor and the control terminal of the second transistor.
